(19) United States
(12) Patent Application Publication
(10) Pub. No.: US 2006/0173722 A1
(43) Pub. Date: Aug. 3, 2006

(54) Method and system for managing documents

(75) Inventor: Akihiro Mizutani, Tokyo (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/044,044

(22) Filed: Jan. 28, 2005

(51) Int. Cl. G06F 9/46

(52) U.S. Cl. 705/8

(57) ABSTRACT

There are provided a method and an apparatus in which data created by scanning bits of information such as characters and figures depicted on the depiction board of an electronic blackboard are stored and managed as image data (documents). According to the apparatus and method, when the image data is preserved into a memory device, power-providing processing to permit only a specified user(s) to access the image data is carried out, the specified user(s) being qualified in advance by a power to perform the access. Thus, a limitation is given to access to minute data (i.e., image data) created by holding a meeting with the use of an electronic blackboard or others, whereby security for the data is enhanced.

### BACKGROUND OF THE INVENTION

1. [Technical Field of the Invention]

The present invention relates to a method and system for managing documents, and in particular, to a document managing system and a document managing method which are useful for storing documents to be collected.

2. [Related Art]

Recent meetings have, like the rest, undergone computerized and networked environments, in which a variety of electronic conferencing systems have been proposed. Particularly, it is expected that networked electronic conferencing systems will provide their usefulness in saving the time and cost, because such systems will realize environments for meetings by connecting, through communication lines, companies which are distant, a head office and its branches, various organizations and others.

Conventionally, by way of example, this networked electronic conferencing system has been known in Japanese Patent Laid-open publication No. 2000-165577.

This patent laid-open publication proposes a conference aiding apparatus that has an electronic blackboard device and a filing device mutually connected via an intranet. In this conference aiding apparatus, the network blackboard transmits recognized image data to the filing device via the intranet, and the filing device stores therein the received image data and manage them in such a manner that the image data can be read out for retrieval.

However, the apparatus described in the foregoing patent laid-open publication has no interest in security, though, under such circumstances, image data of, for example, meeting minutes are stored in the filing device. In companies which adopt up-to-date employment systems, staff working on a variety of working systems (such as staff from affiliated companies, temporary staff, staff on outsourcing, part-timers etc.) uses the same communication infrastructure. Thus, it is usual that any person can have access to the server at any time, provided that both of a user ID and a password are given. The system according to the foregoing patent laid-open publication is therefore vulnerable to management of information about minutes depicted on the blackboard after meetings have been finished.

### SUMMARY OF THE INVENTION

The present invention provides a method and an apparatus in which data produced by scanning information such as characters and figures are stored for management thereof, as image data (documents).

Specifically, the present invention provides, as one mode thereof, a document managing apparatus comprising: a data storing unit storing into a memory device image data produced by scanning image information; and a power providing unit allowing only a user to access the image data stored in the memory device by the data storing unit, the user being given a power to perform the access in advance.

As another aspect, the present invention provides a document managing apparatus comprising: data storing means storing into a memory device image data produced by scanning image information; and power providing means allowing only a user to access the image data stored in the memory device by the data storing means, the user being given a power to perform the access in advance.

Further, as another aspect, the present invention provides a document managing method comprising steps of: receiving image data produced by scanning image information; and when the image data is stored into a memory device, allowing only a user to access the image data, the user being given the access in advance.

As another aspect, the present invention provides a program executable by a computer and causing the computer to function as means comprising: data storing means storing into a memory device image data produced by scanning image information; and power providing means allowing only a user to access the image data stored in the memory device by the data storing means, the user being given a power to perform the access in advance.

### BRIEF DESCRIPTION OF THE DRAWINGS

In the accompanying drawings:

FIG. 1 is a block diagram showing the overall configuration of a meeting aiding system in which a document managing apparatus according to the present invention is reduced into practice in an integral manner;

FIG. 2 is a block diagram showing the configuration of a computer of a center server incorporated in the meeting aiding system;

FIG. 3 exemplifies meeting-room booking data stored in a meeting-room booking database placed in the center server;

FIG. 4 exemplifies meeting document data stored in a meeting-dedicated document database placed in the center server;

FIG. 5 is a flowchart outlining preparing processing performed at a time when it is 5 minutes to a meeting to be scheduled, which is carried out by the computer of the center server;

FIG. 6 is a view explaining changes in the display screen of an MFP apparatus placed in a meeting room, the changes being caused through the preparing processing at the time when it is 5 minutes to the meeting;

FIG. 7 is a flowchart outlining preparing processing performed at a time when it is 3 minutes to the meeting to be scheduled, which is carried out by the computer of the center server;

FIG. 8 is a view explaining changes in the display screen of the MFP apparatus placed in the meeting room, the changes being caused through the preparing processing at the time when it is 3 minutes to the meeting;

FIG. 9 is a view explaining meeting documents on which an individual's name is indicated, which are printed under the preparing processing at the time when it is 3 minutes to the meeting;

FIG. 10 is a flowchart outlining management processing of meeting minutes, which is performed by the computer of the center server;

FIG. 11 explains meeting minute data collected by scanning an electronic blackboard and a meeting participants' reference table;

FIG. 12 is a flowchart outlining detection and recognition of blanks of a predetermined size in meeting minute data (i.e., image data on a depiction board), the detection and recognition being performed in the management processing for the meeting minutes;

FIG. 13 explains the size of an area necessary for attachment of meeting calling information;

FIG. 14 explains an area for attaching meeting calling information, the area being present in meeting minute data (i.e., image data on the depiction board);

FIG. 15 is another view explaining an area for attaching meeting calling information;

FIG. 16 is a view explaining meeting minute data to which information indicative of an access right holder after database storage is attached;

FIG. 17 explains the attachment of meeting calling information to meeting minute data (i.e., image data on the depiction board);

FIG. 18 explains a screen for a list for selecting the number of printing sheets, the list being provided by an MFP apparatus when meeting minutes are printed on sheets of paper;

FIG. 19 is a flowchart outlining booking a meeting room to be used for the next meeting, the booking being carried out at a time instant when a predetermined period of time is left to the end of a meeting;

FIG. 20 explains an access operation conducted by the center server, the access being carried out through the meeting-room booking processing; and

FIG. 21 is a view showing a screen for selecting a meeting room, the screen being provided by an MFP apparatus during the meeting-room booking processing.

### DETAILED DESCRIPTION OF PREFERRED EMBODIMENT

Hereinafter, an embodiment of the present invention will now be described.

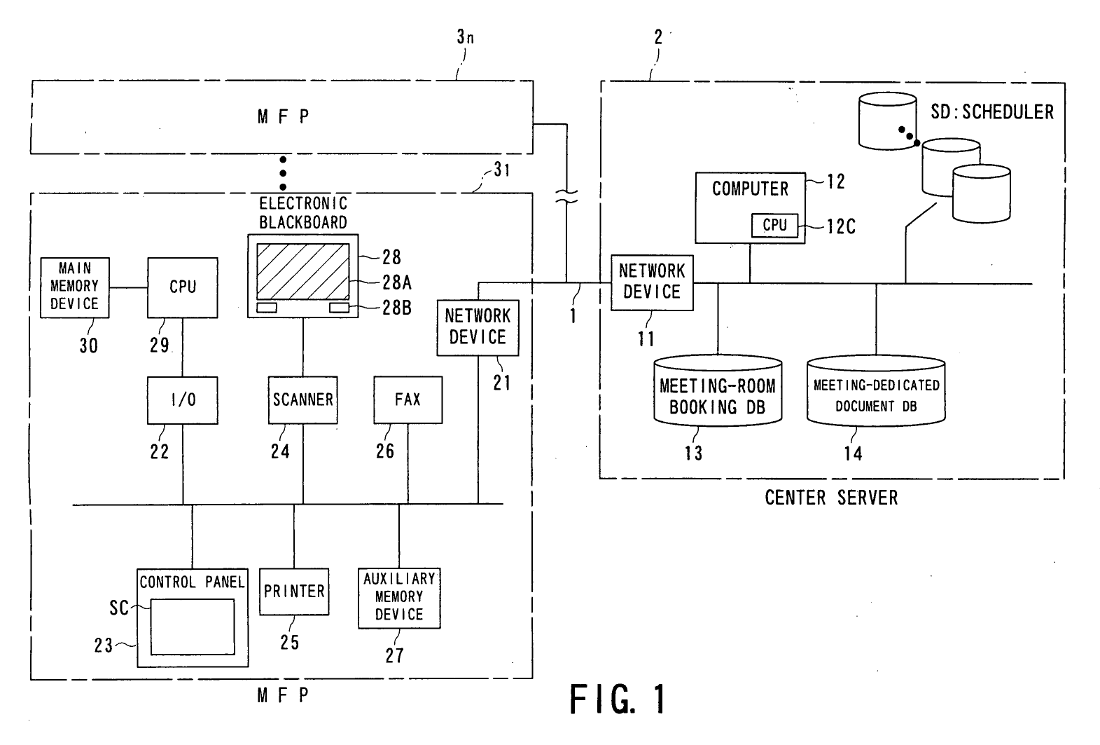

FIG. 1 outlines the configuration of a meeting (conference) aiding system reduced into practice, integrally with a document management apparatus according to an embodiment of the present invention.

This meeting aiding system is provided with a single center server 2 mutually connected with terminals via a LAN (local area network) 1 serving as a communication line 1 and a plurality of MFP (multi-function peripherals apparatuses 3 (3₁, . . . , 3ₙ) serving as the terminals.

Of these the LAN 1 is communicable based upon the standards of, for example, the Ethernet. Instead of the LAN 1, the public network or Internet may be used.

The center server 2 is provided with a network device 11 connected with the LAN 1, a computer 12 performing control for aiding meetings, a meeting-room booking database (DB) 13 storing therein data in relation to booking of meeting rooms, and a meeting-dedicated document database 14 storing therein data in relation to computerized documents for meetings, and these apparatuses 11 to 14 are configured to be communicable on data with each other via a control bus 15.

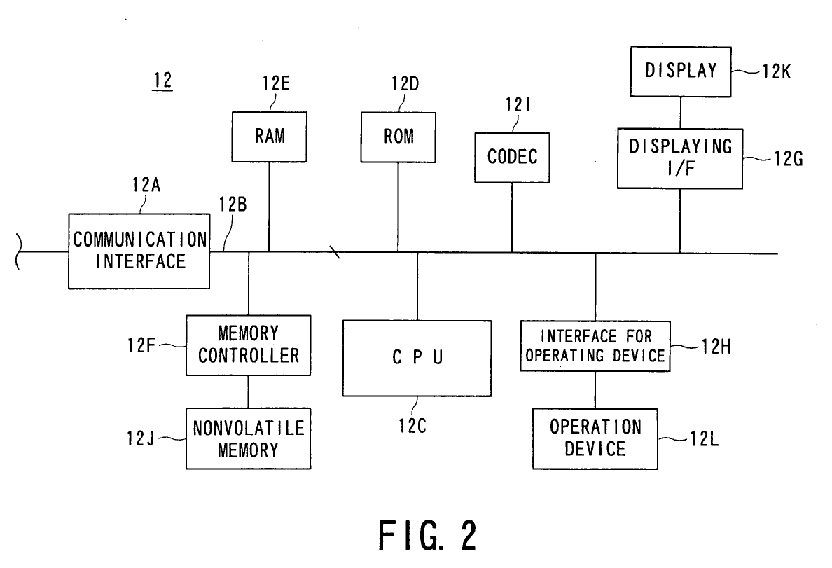

Practically, the computer 12 is composed as a personal computer (PC), for instance. As shown in FIG. 2, this computer 12 is equipped with a communication interface 12A connected with both of the external LAN 1 and the internal bus (control bus and data bus) 12B. The computer 12 is also equipped with a CPU (central processing unit) 12C connected with the bus 12B, a ROM 12D, a RAM 12E, a memory controller 12F, a displaying interface 12G, an operating-device-dedicated interface 12H, and a codec 12I. While a nonvolatile memory 12J is connected with the memory controller 12F, a display 12K is connected with the displaying interface 12G and an operation device 12L is connected with the operating-device-dedicated interface 12H, respectively.

Of these, various types of data are transmitted and received between the communication interface 12A and the LAN 1. The CPU 120 controls programs stored in advance in the ROM 12D, so that the CPU 120 is able to perform various types of processing necessary for controlling the meeting aiding system in cooperation with CPUs owned by the plurality of MFP apparatuses under control of the CPU 12C. Therefore, the ROM 12D functions as a recording medium in which data indicative of a variety of programs are pre-recorded, which will be described later.

The memory controller 12F is placed for transmitting data between the nonvolatile memory (hard disk, CD and others) 12j and the RAM 12E. The displaying interface 12G is placed for communication of image data to be displayed on the display 12K. Further, the operating-device-dedicated interface 12H interfaces with operation signals coming from various operation devices (such as a keyboard and/or a mouse) that compose the operation device 12L. The codec 12I is placed for encoding/decoding audio data and encoding/decoding video data.

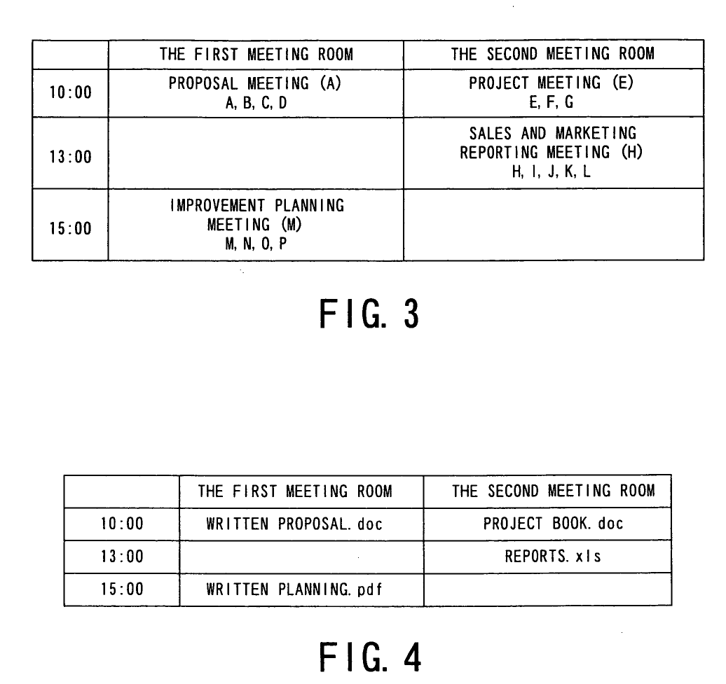

On the other hand, the meeting-room booking database 13 stores therein pieces of information such as booking date and hour for each meeting room, the names of meeting rooms, the names of persons who books meeting rooms, and participants in meetings. FIG. 3 exemplifies meeting-room booking data. As shown therein, every meeting room, data indicative of meeting titles, booking person's names, and participants are registered along the date and hour zone in the form of tables. Further, the meeting-dedicated document database 14 is a database for uploading therein document data necessary for meetings and is linked with the meeting-room booking database 13. FIG. 4 shows an example of meeting document data. As shown in FIG. 4, every meeting room, the database 13 stores therein data of meeting document data in accordance with the booked date and hour zone.

Incidentally, in the center server 2, there are provided schedulers SD managed by individuals, respectively.

Each of the plurality of MFP apparatuses 3 is a multifunctional device installed in each meeting room. Practically, each MFP apparatus 3 is provided with a network device 21 intervening between an internal control bus 20 and the external LAN 1, an input/output (I/O) controller 22 connected with the bus 20, a control panel 23, a scanner 24, a printer 25, a fax device 26, and an auxiliary memory device 27, which are signal-communicable with each other through the bus 20.

Among those components, the printer 25 operates as a printing device in the MFP apparatus 3. The control panel 23 provides a large-scale display screen SC which is made as a touch panel type and associated with the printer 25. The scanner 24, which is equipped as part of an electronic blackboard (also called “white board”) 28, is able to read out data depicted on the electronic blackboard as image data.

Each MFP apparatus 3 is provided with a CPU (central processing unit) 29 for reading and writing data via an input/output controller 22 and a main memory device 30 in which predetermined unchanging data and program data required by the CPU 29 are stored in advance. Thus, in response to the activation, the CPU 29 will start to read the program data out from the main memory device 30 and engage in necessary calculation and control based on the procedures provided by the programs. The data necessary for the calculation and control are read into the CPU 29 through the input/output controller 22, while resultant data from the calculation and control are outputted from the CPU 29 via the input/output controller 22.

By the way, a variety of types of processing which relates to aiding meetings is carried out in the present embodiment, in which the CPU 12C of the computer 12 in the center server 2 plays a main role of the performance of those types of processing. That is, the CPU 29 operates in response to instructions from the CPU 12C, so that processing of display, printing, scanning, reading of operation signals, and others, which are necessary for each MFP apparatuses 3, can be accomplished. It thus can be said that the various types of processing performed by each MFP apparatus 3 are under the control of the computer 12 of the center server 2.

Alternatively, however, the CPU 29 of each MFP apparatus 3 may be placed to execute the necessary processing, independently of the computer 12 of the center server 2. In such a control configuration, it is sufficient that the CPU 29 executes data communication with the center server 2 only when the need arises.

In the present embodiment, the processing executed by the CPU 29 of each MFP apparatus 3 disposed in each meeting room, which is under the control of the computer 12 of the center server 2, will now be detailed.

The computer 12 in the center server 2, one main constituent of which is the CPU 12C, performs the processing based on given programs, with the result that, in each meeting, the various types of processing are activated sequentially to the elapse of time in an automatic fashion or are activated responsively to user's instructions. Hereinafter, the computer 12 is simply referred to as a “server-side computer.” To be more specific, as to a certain meeting, sequentially activated are:
preparation processing performed at a time when it is 5 minutes to the meeting,
preparation processing performed at a time when it is 3 minutes to the meeting (checking attendances and printing),
management processing of meeting minutes, and
meeting-room booking processing for the next meeting.
Thereinafter, those various types of processing will now be described.

[5-Minutes-To-Meeting Preparation Processing]

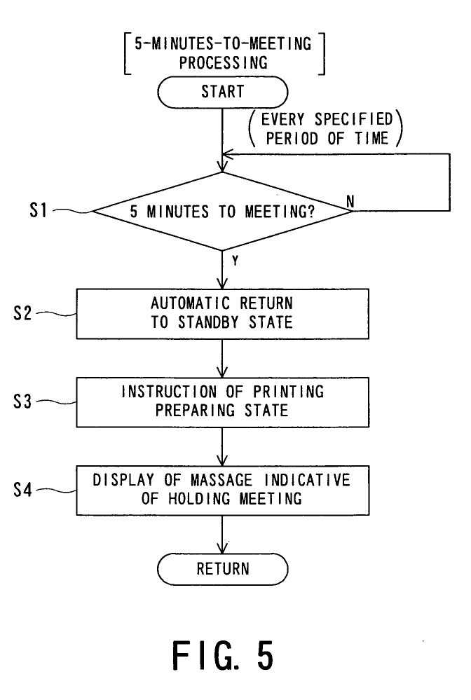

In cooperation with the CPU 29 of each MFP apparatus 3, the server-side computer 12 performs 5-minutes-to-meeting preparation processing based on the processing shown in FIG. 5. The processing shown therein is activated at predetermined intervals on a timer interruption basis.

The server-side computer 12 always monitors the day and hour to determine whether or not it is a time when it is 5 minutes (i.e., a first predetermined period of time) to the start time of a specified meeting to be scheduled (step S1 in FIG. 5). When the determination is NO, that is, it has not been 5 minutes to the start time, the computer waits for the next action, with the processing for the above time elapse determination repeated in the same manner. In contrast, when the determination is YES, that is, it is 5 minutes to the meeting start time, an instruction is issued to automatically return the meeting-room MFP 3 to its standby state (step S2). Then the server-side computer 12 orders the printer 25 to its printing preparation state (step S3). The server-side computer 12 then orders the display of the date and hour of a meeting to be held, the tile of a meeting, and the name of a person who booked the meeting on the screen SC of a large-size display of the control panel 23 (step S4).

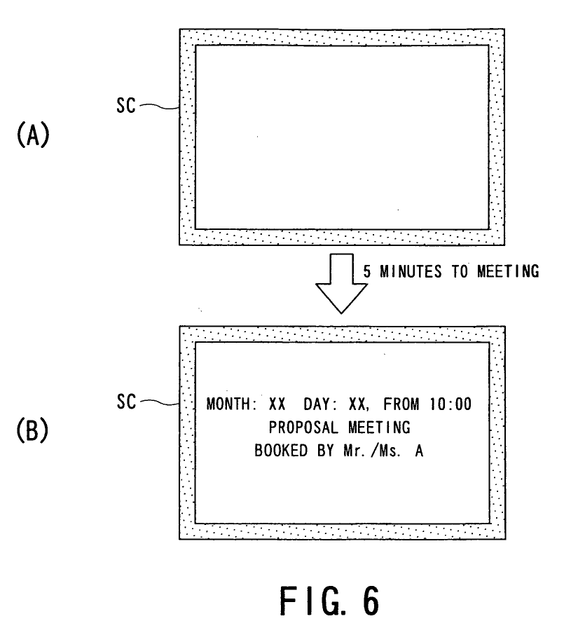

As a result, on the large-size display screen SC of the control panel 23 which has displayed no message until the time when 5 minutes are left to the start time of the meeting to be held (refer to FIG. 6(A)), a message indicative of holding the meeting is displayed, as shown in FIG. 6(B), when it is 5 minutes to the start time of the meeting. Thus participants who have come to the meeting room to attend the meeting are able to know that the meeting will be held.

[3-Minutes-To-Meeting Preparation Processing]

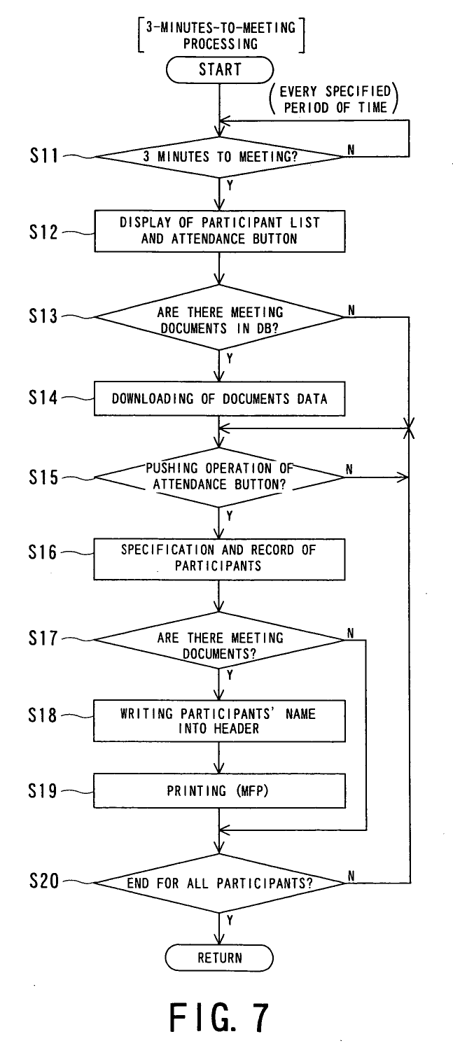

After having completed the above 5-minutes-to-meeting preparation processing before the meeting, the server-side computer 12 still cooperates with the CPU 29 of each MFP apparatus 3 to monitor the time and to perform 3-minutes-to-meeting preparation processing based on the processing shown in FIG. 7. The processing shown therein is also activated at predetermined intervals on a timer interruption basis.

The server-side computer 12 determines whether or not it is 3 minutes (i.e., a second predetermined period of time) to the start time of the designated meeting to be scheduled (step S11 in FIG. 7). If this determination is NO, that is, it has not been 3 minutes to the meeting, the above time-elapse determination is repeated to wait, during which waiting time the screen SC of the large-size display maintains the displayed state shown in FIG. 6(B).

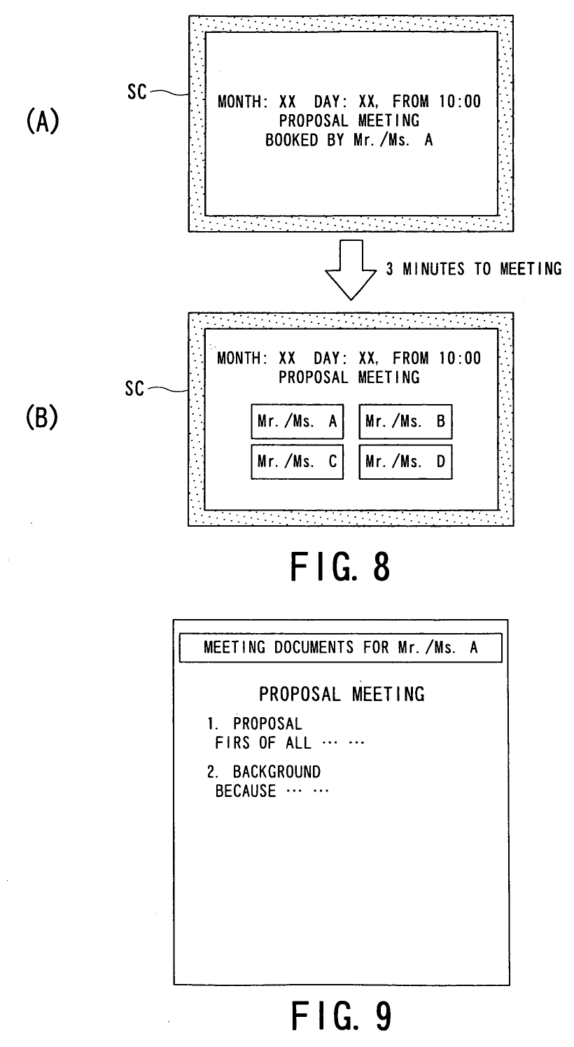

By contrast, when the determination at step S11 becomes YES, i.e., it is 3 minutes before the meeting start time, the server-side computer 12 issues a command which allows the screen SC of the large-size display of the control panel 23 to present the display of both a list of participants who attend the meeting and attendance buttons B which can be pressed by each participant (refer to step S12 and FIG. 8 (B)).

The server-side computer 12 then determines whether or not the meeting-dedicated document database 14 memorizes documents data relating to the meeting to be held this time (step S13). This determination reveals that there are relating document data in the database (YES at step S13), the document data is downloaded from the database 14 and spooled into the hard disk (composing the auxiliary memory device 27) and a command to temporarily store the data in a folder of the hard disk is issued (step S14). However, whenever there is no document data in the database 14 (NO at step S13), this downloading processing is skipped.

The server-side computer 12 then waits for the next action, while repeating the determination of receiving a signal indicating that each of the attendance buttons on the large-size display screen SC of the control panel 23 has been pressed down (step S15). If any of these attendance buttons is pressed down (YES at step S15), a participant's name is interpreted and memorizes as a “participant” (step S16). Accordingly, for example, data that shows “the participation of Mr./Ms. A” is added to meeting data in the MFP apparatus 3.

The server-side computer 12 then determines whether or not there are any meeting documents (materials) spooled in each MFP apparatus 3 (step S17). Whenever it is determined that there are spooled meeting documents, the server-side computer 12C issues an order to add, for example, data of “meeting documents for Mr./Ms. A” to the header of the documents (step S18 and refer to FIG. 9). The name to be added corresponds to the designated participant through the process at step S16. Then issued is an instruction to cause the printer 25 to print the data of the meeting document on which the name is indicated (step S19). As illustrated in FIG. 9, therefore, in place of simple printing, the meeting documents can be printed to have participant's name indicated thereon as a document header and handed to each participant.

Further, an object to be indicated on the document header is not always limited to the participant's name, but it is preferable that the indication includes information indicative of an individual or group (such as an individual's name and/or group name). The reason is that, if such names appear on meeting documents that have been printed, the names might work as a kind of resistance against careless losses, which is preferable from the viewpoint of raising ability in security of the meeting documents. If a certain document with a participant's name on is left, it is easy to know at a glance who should own such a document and who should have responsively for management of the document. Further, the names on documents are useful in filing the documents in binders.

On the other hand, when it is determined NO at step S17, the situation is such that the meeting will be held without using any meeting documents to be distributed to each participant, at least, through this system. Thus, in this case, the processing at steps S18 and S19 are skipped.

Moreover, the server-side computer 12 determines whether or not all the participants who are scheduled to attend the meeting have finished to pressing the attendance buttons BT (step S20). When all the participants have finished such actions, the processing will be ended (YES at step S20). However, it is determined that there remain one or more participants who have yet to finish pressing the attendance buttons, the server-side computer 12 shifts its processing to step S15.

FIG. 8 provides two depictions (A) and (B). One depiction (A) exemplifies the contents that have been produced through 5-minutes-to-meeting preparation processing and have been presented on the large-size display screen SC of the control panel 23, while the other depiction (B) realized through 3-minutes-to-meeting preparation processing exemplifies the display on the screen SC on which the attendance buttons BT appear.

As a result, at a time when the 3-minutes-to-meeting preparation processing is finished, the participants who actually attend the meeting are allowed to operate, for themselves, the attendance buttons to register data showing the attendance. Each MFP apparatus 3 is therefore able to acquire data about the persons who are actually present or absent. Therefore, in acquiring such data showing the actual presence and absence, cumbersome work including input operations of ID Numbers become unnecessary. A simple work that the attendance buttons on the display screen should be pressed down is sufficient.

Additionally, in response to pressing the button for checking the attendance, the application software for printing is automatically activated. Thus, the MFP apparatus 3 placed in the meeting room is able to not only print, on the spot, meeting documents prepared in advance for distribution to the participants but also check the attendances. Because labor for handling the printing application can be saved, efficiency in the operations is improved. Further, such printing is performed to provide documents used by actual attendants, whereby the documents can be prevented from being printed more than necessary. This contributes to resource saving.

The foregoing process that the data of the meeting documents are downloaded from the center server may be replaced by the following modification. Specifically, meeting documents (materials) that are able to specify individuals to be present at a meeting are produced beforehand and their data are stored in a hard disk of the MFP apparatus. On the spot, the data of the meeting documents are subjected to printing and distribution to each participant.

[Management Processing For Meeting Minutes]

In addition to the above, the center server 2 responds to a printing command received during a meeting so that it commands the CPU 29 of each MFP apparatus 3 to manage (i.e., print and store) data written on the depiction screen 28A (refer to FIG. 1) of the electronic blackboard 28.

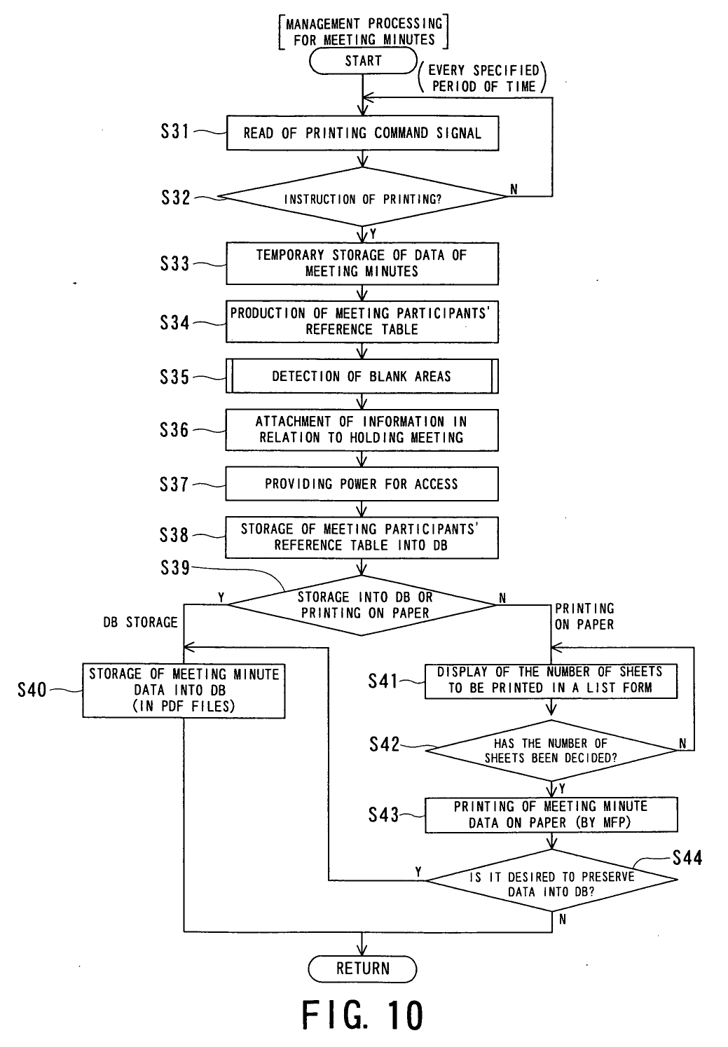

FIG. 10 outlines the management processing performed by the computer 12 (server-side computer) including, as one of the main constituents, the CPU 12C of the center server 2, in cooperation with the CPU 29 of each MFP apparatus 3.

In cases where a user pressed a “sprinting” button 28B (refer to FIG. 1) on the electronic blackboard during the period of the scheduled meeting, a signal indicating this operation is sent to the center server 2 via each MFP apparatus 3. The server-side computer 12 thus tries to read in the signal showing this pressing operation (step S31 in FIG. 10), and then determines whether or not a printing instruction has been issued (step S32). The printing instruction based on the “printing” button 28B is for outputting the information written on the depiction board 28A. Thus the printing instruction is not merely for printing but also for management processing for the information on the depiction board.

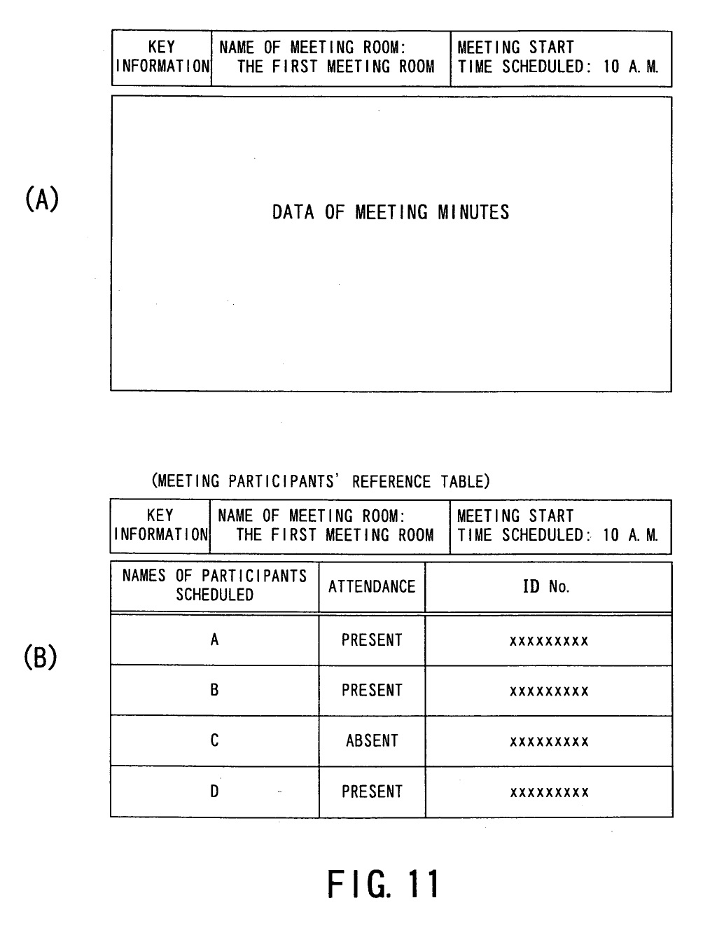

When the printing instruction is detected by the CPU 29, the MFP apparatus 3 activates the scanner 24. The scanner 24 scans the depiction board 28A of the electronic blackboard 28 on an optically reading manner, and creates, as image data, the information written thereon (that is, minutes of the meeting) (refer to an illustration (A) in FIG. 11). The minute data (image data) are sent to the center server 2. The minute data accompanies information in relation to the name of a meeting room (for example, the first meeting room) and a meeting start time to be scheduled (for example, 10:00 a.m.), in which such pieces of information serve as key information identifying the minute data. As data serving as this key information, a data ID number may be set separately from the minute data and such data ID number may be used.

When the server-side computer 12 recognizes the printing instruction (YES at step S32 in FIG. 10), it receives the minute data (image data) transmitted from the MFP apparatus 3 and temporarily preserves the data in the memory 12J (step S33).

Then the center-side computer 12 reads out data indicative of participants in the meeting (participants to be scheduled) from the corresponding meeting-room booking data preserved in the meeting-room booking database 12, and compares this read-out data with the attendance data which has already been found, whereby a meeting participants' reference table is produced in which the participants' ID numbers are listed in a comparative way (step S34; refer to an illustration (B) in FIG. 11). The data of this reference table is temporarily memorized in the memory 12J. This reference table also uses, as key information, the meeting room name and the meeting start time scheduled. The ID numbers of the participants may be stored in any of the databases 13 and 14 in advance or may be obtained by making reference to individuals' schedulers.

The server-side computer 12 then performs in sequence the judgment of blank areas in the minute data to be printed (step S35), the addition of information indicative of holding the meeting (step S36), and the addition of power to access preserved data (step S37).

First of all, the judgment of blank areas in the minute data to be printed will be detailed. The reason why this judgment is needed is as follows. On the depiction board 28A of the electronic blackboard 28, various data such as figures and characters are depicted (written), and such data are outputted (printed and/or preserved in the database) through its scanning. In such a case, however, it is not always that such data accompany information showing holing a meeting (day and hour of the meeting to be held, place of the meeting to be held, participants' names to be booked, and others). Though the title, purpose, and other information of and about a meeting are frequently written on the depiction board 28A of the electronic blackboard 29, it is not always true that the information showing holing the meeting is additionally written on the depiction board. Even when the electronic blackboard 28 is originally planned not to be used during a meeting, a need for writing on the board may arise. In such a case, it is normal that only necessary articles are written thereon alone, with no information showing the holding the meeting. It is therefore more convenient that minute data from the electronic blackboard 28 necessarily accompanies information showing holing the meeting, because a reference to the minutes can be made easier later. Thus the blank areas are judged to find blank areas (spaces) in the minute data to be printed and the meeting holding information is fit into the found blank areas.

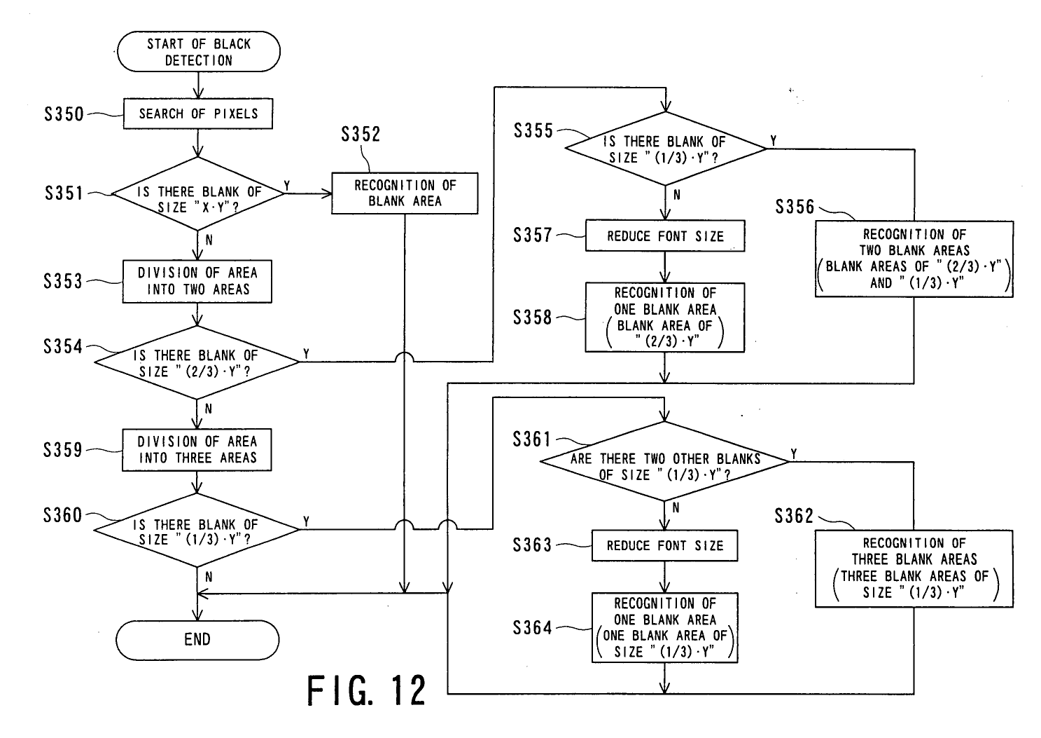

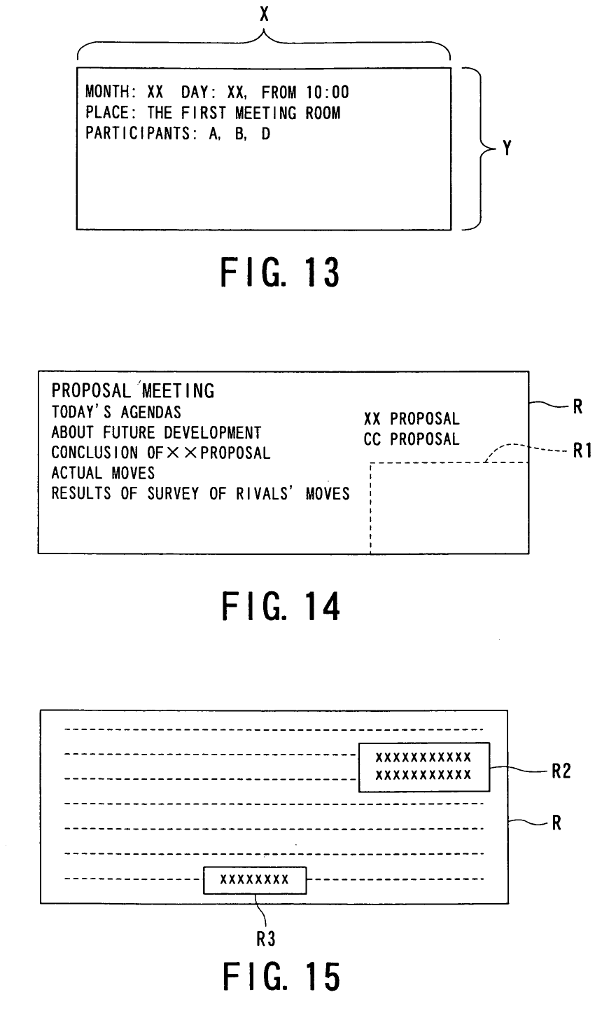

The blank judgment will now be explained in connection with a subroutine shown in FIG. 12. The server-side computer 12 understands the meeting holding information (in the present embodiment, a day and hour of a meeting to be held, a place of the meeting to be held, and booked participants' names) as spaces which should be assigned to figures. Namely, as shown in FIG. 13, a size “X·Y” required when the meeting holding information is depicted using a character of a predetermined font size is memorized beforehand. Because this example shows a situation where the day and hour, place, and participants' names are to be written in three lines, a space assigned to each line is Y/3.

Using minute data temporarily stored in the memory 12J, that is, digitized black/white pixel data that form a region R on the depiction board to be scanned (refer to FIG. 14), the server-side computer 12 searches for each pixel that has no pixel value corresponding to the digitized pixel data (step S350). Then, based on the searched results of the pixels, the server-side computer 12 determines whether or not there are some blank areas of the “X·Y” size (areas with no characters and figures depicted) in the minute data to be printed, i.e., the scanned region R of the depiction board (step S351). Hence, in the case that, as shown by a reference R1 in FIG. 14, there is a blank area of the predetermined size “X·Y” in the minute data to be printed (i.e., in the depiction board region R) (YES at step S351), information showing the addresses of this blank area is memorized (step S352).

However, if there is no such a blank area of the predetermined size “X·Y”, that is, the depiction board 28A is full of characters and figures, obtaining a single predetermined-size area will be abandoned (NO at step S351). In this case, the area into which the information about holding the information is attached is divided (step S353). Practically, the size “X·Y” is divided into sizes of “X·2Y/3” and “X·Y/3.” Then it is determined whether or not one or more blank areas of the size “X·2Y/3” exist in the minute data to be printed (the depiction board region R) (step S354). If YES at this determination, it is determined whether or not one or more blank areas of the size “X·Y/3” exist in the depiction board region R (step S355). Still the answer YES at this determination suggests that the division into the two areas provides one area R2 of the size “X·2Y/3” and the other area R3 of the size “X·Y/3,” as shown in FIG. 15, so that information indicative of the addresses of the two blank areas R2 and R3 is memorized (step S356). On the other hand, in cases where the determination at step S355 is NO, the character font size for the meeting holding information is reduced down to a maximum size in which all the meeting holding information is fit into the blank area of the size “X·2Y/3” (step S357). Then information indicative of the area of the size “X·2Y/3,” which has already been confirmed, is memorized (step S358).

Furthermore, in cases where it is impossible to obtain the foregoing blank area of the size “X·2Y/3” (NO at step S354), the sever-side computer 12 divides the size “X·Y” into three sizes each having “X·Y/3” (step S359). Then it is determined whether or not one blank area of the size “X·Y/3” exists in the minute data to be printed (in the depiction board region R) (step S360). If YES at this determination, it is then determined whether or not the remaining two blank areas each sized into “X·Y/3” exist in the minute data (in the depiction board region R) (step S361). Still the answer YES at this determination suggests that the division into the three areas provides the three areas each having the size “X·Y/3,” so that information indicative of the addresses of the three blank areas is memorized (step S362). On the other hand, in cases where the determination at step S361 is NO, the character font size for the meeting holding information is reduced down to a maximum size in which all the meeting holding information is fit into the one blank area of the size “X·Y/3” (step S363). Then information indicative of the one area of the size “X·Y/3,” which has already been confirmed, is memorized (step S364).

As described above, there are obtained one or more small areas R1 (to R3) which can accept the information indicative of holding a meeting. That is, such information can be added to the minute data written on the depiction board region R scanned (refer to FIG. 14).

After completing the judgment for the blank areas, the server-side computer 12 shifts the processing to step S36 shown in FIG. 10, and actually attaches the meeting holding information to the obtained small areas R1 (to R3). This processing is carried out by reading the address information concerning the memorized small areas R1 (to R3), which is processed through the processing in FIG. 12, and then adding characters based on the meeting holding information to the small areas R1 (to R3) produced by such positional information. The minute data which has been subjected to the addition is temporality stored into the memory 12J.

Incidentally, when such a plurality of divided small areas are obtained, the attachment is made such that the day and hour, place and participants, which compose the meeting holding information, are placed in sequence in the plural small areas, on the assumption that such plural small areas are connected to one. Hence, in the example shown in FIG. 15, characters indicating the day and hour and place of the current meeting are attached to an upper small area R2, while characters indicating the participants in the meeting are attached to a lower small area R3.

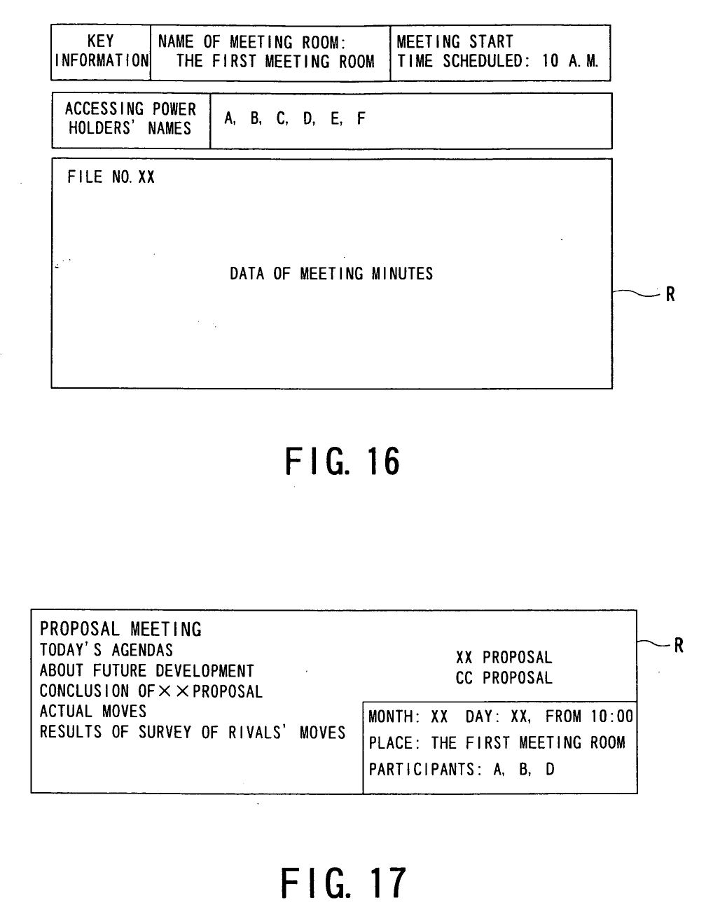

After completion of this processing, the server-side computer 12 proceeds to the processing to provide a user with power for accessing the stored data (step S37). That is, the server-side computer 12 makes reference to the meeting participants' reference table (step S37) temporarily stored in the memory 12J and adds, to the key information of the minute data, data indicative of persons who are allowed to have access to the minute data. By way of example, such persons are all the originally scheduled participants A to D including members who have actually attended the meeting. Such minute data are pictorially shown in FIG. 16.

Alternatively, the access-allowed persons may include some persons who have some relation to a meeting (e.g., chief), not limited to persons who plan to attend the meeting originally. To the contrary, such access-allowed persons may be limited to actually attended persons to a meeting by using the attendance data. Adding and deleting some persons to and from the access-allowed persons can be conducted by having access to the server-side computer 12 via each MFP apparatus 3.

As described above, when providing some members with the right of access through appropriate setting, the server-side computer 12 moves to storing the meeting participants' reference table into the meeting document database 14 (step S38).

When the preparation has been completed in this way, the server-side computer 12 enquiries a user of how to output the minute data through the MFP apparatus 3 (step S39). With this enquiry, the user is asked to detect whether or not the minute data should be stored in the database or printed on sheets of paper. If the user selects storing into the database, the minute data (refer to FIG. 7) to which the information about the currently held meeting is attached is converted into a PDF file to be stored into the meeting-dedicated document database 14 (step S40).

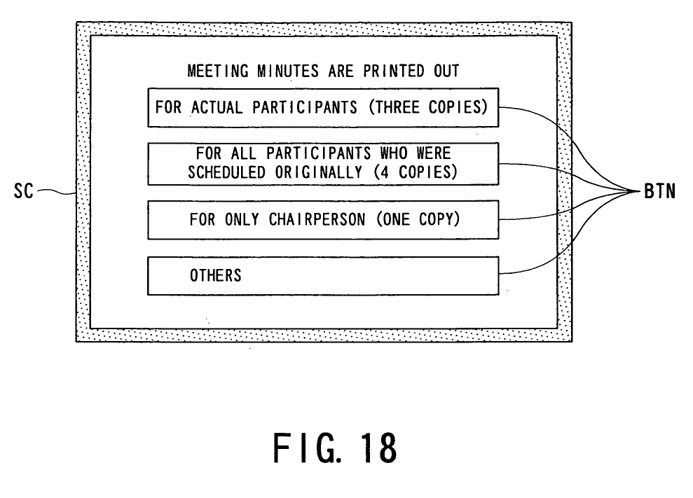

In contrast, the user can select the paper-printing of the minute data. In this case, the server-side computer 12 commands the MFP apparatus 3 to display on the control panel 23 a button BTN to enquire the number of sheets of paper to be printed, as shown in FIG. 18 (step S41). This button BTN has option buttons with which the user is able to decide the number of printed sheets depending on which person to receive the distribution. When the number of printed sheets is decided (step S42), the printer 25 of the MFP apparatus 3 is instructed to print the minutes by the decided number of sheets (step S43). This enables the participants in the meeting to timely obtain the minutes with the information about the currently held meeting on the spot.

The server-side computer 12 makes sure whether the minute data is required to be preserved in the database by enquiring the user again (step S44). If this enquiry reveals that there is no need for preserving the data into the database, the processing is ended. By contrast, the answer is that preserving the data into the database is necessary, the processing at step S40 is again performed, so that the minute data is converted into a PDF file and stored into the meeting-dedicated document database 14, before the processing is ended.

[Processing For Booking A Meeting Room For The Next Meeting]

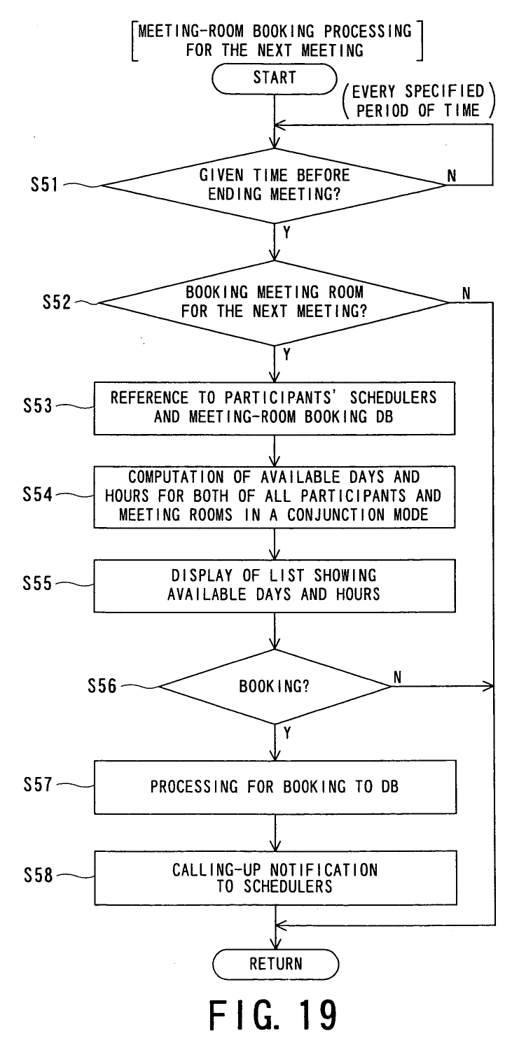

The processing for booking a meeting room for the next meeting, which is carried out by the server-side computer 12, will now be described. This processing is outlined by FIGS. 19-21, in which a flowchart shown in FIG. 19 is executed at intervals by the server-side computer 12 on a timer interruption basis, in cooperation with the CPU 29 of each MFP apparatus 3.

The server-side computer 12 repeats the determination whether or not it is a time when a predetermined period of time (for example, 10 minutes) is left to a scheduled end time of the meeting (step S51 in FIG. 19). In response to the determination YES at this step, an enquiry to the participants is made through the large-size display screen SC of the control panel 23 of each MFP apparatus 3 as to whether or not it is required to book a meeting room for the next meeting (step S52). The reply that it is not necessary to book the next meeting room will cause the processing to return to a main program, while the opposite rely is gained (the booking is necessary for the next meeting), the processing proceeds to step S53 and subsequent steps in turn.

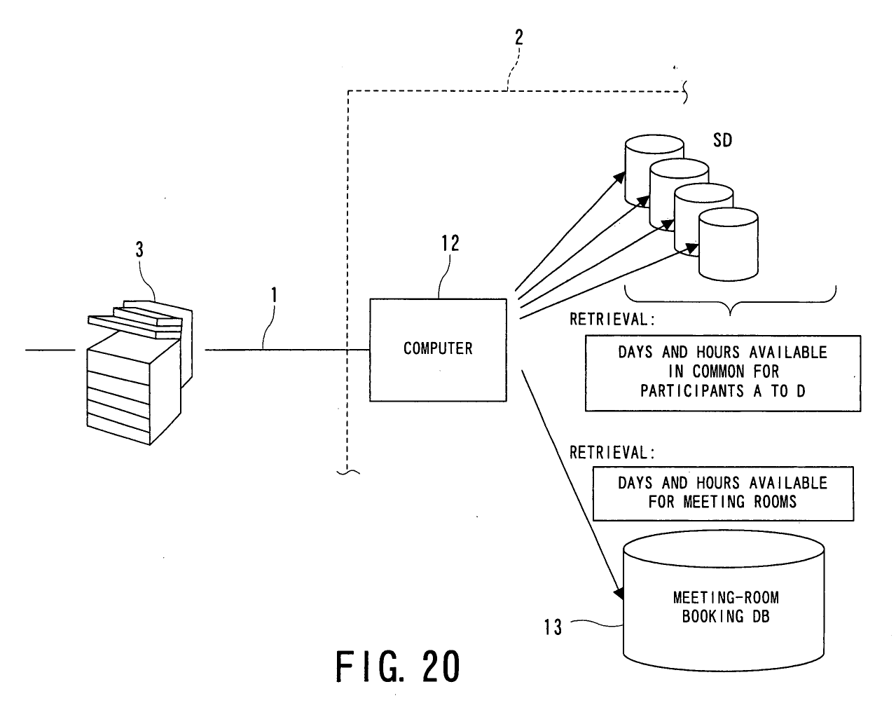

First of all, schedulers SD (refer to FIG. 20) managed by the respective members who are in the meeting are made reference to search for a day and hour that are available in common for all the participants, and concurrently the meeting-room booking database 13 is subjected to access to search for available hours and times and available meeting rooms (step S53). Then, a conjunction between these day and hour conditions is conducted to decide one or more days and hours which are available in common for both of the participants and the meeting rooms, and a list of the one or more days and hours is instructed to be displayed on the large-size display screen SC of the computer panel 23 of each MFP apparatus 3 (steps S54 and S55).

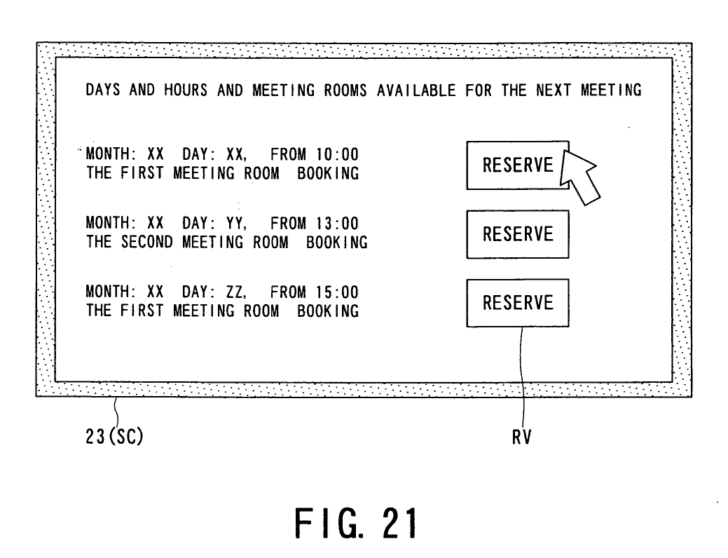

An outline of this search processing is shown in FIG. 20, while a list to be displayed is exemplified in FIG. 21. The list includes a booking button RV each set of an available day and hour, and meeting room. Hence the participants are able to designate the most convenient day and hour on the spot by pressing a desired booking button.

The server-side computer 12 monitors a pressing action onto the booking buttons, and if booked, data indicating the booking is sent to the meeting-room booking database 13 for registration (steps S56 and S57). In addition, a calling-up notification for the next meeting, which is based on the booked data, is transmitted to each of the participants' schedulers SD (step S58).

Though being not detailed, a screen associated with the above list can be used on the spot to designate a person who booked the next meeting and/or participants scheduled to attend the next meeting. In such a case, the actual participants in the current meeting are treated as initial values for participants in the next meeting, so that the same participants in both of the current meeting and the next meeting, entering the participants is made easier, thus saving manual labor for the entry.

Then the server-side computer 12 returns the processing to the main program and sets ready for the next meeting which is scheduled at the meeting room in which the MFP apparatus 3 is placed. Namely, the computer 12 sets ready for the forgoing 5-minutes-to-meeting preparation processing.

As described above, according to the meeting aiding system integrally including the document managing apparatus according to the present embodiment, the following operations and advantages are provided.

First, a fundamental operation and advantage is to add the right of access to the image data (document data) acquired from the electronic blackboard and stored in the meeting-dedicated document database 14 of the center server 2, the right of access allowing only qualified users to have access to the image data. Thus, even when, as today's companies, a company has various business systems on which various types of staff work using the same database, minutes acquired from the electronic blackboard can be managed thoroughly. Accordingly, when a meeting is held with the use of an electronic blackboard, information written on the board, that is, the minutes can be managed in a strengthened security.

In addition to the foregoing basic advantage, the present embodiment according to the present invention still provides a variety of operations and advantages.

First, the image data acquired from the electronic blackboard is subjected to the addition of information about holding a meeting, which serves as management data, and stored in the database. Hence, for writing characters and others on the description board of an electronic blackboard, it is unnecessary for users to purposely write information such as day and hour, room name, and participants of and in a meeting, whereby work for using the electronic blackboard can be facilitated. In addition, even for printing and consultation to be conducted later, the meeting holding information can be used effectively, because such information is always attached to the image data.

In the apparatus according to the present embodiment, the above information about holding a meeting, that is, the meeting holding information, is automatically attached to the image data, after checking one or more blank areas in an area consisting of the image data. Hence a burden exerting on users can be lightened. What's more, whenever characters etc. are written on the entire depiction screen of an electronic blackboard, one or more blank areas of a small, but appropriate size are found in an area consisting of the image data, that is, on the board, and meeting holding information adjusted to an appropriately-size font is attached to the blank areas in an automatic fashion. Hence, the users are able to write on the depiction screen, with no particular attention paid to the spaces for adding the meeting holding information.

The minutes of each meeting can converted into PDF-format files to be stored into the meeting-dedicated document database 14, and/or printed on paper. It is therefore convenient for users to preserve the minutes.

Further, according to the present embodiment, when it is 5 minutes (the first predetermined period of time) to the start time of a scheduled meeting, the MFP apparatus 3 takes a standby state automatically, and a message informing that the meeting will be held soon is displayed on the screen of the control panel 23 of the MFP apparatus 3. Hence, it is possible for a member who takes care of opening a meeting or chairman to save labor in running the meeting.

In addition, when it is 3 minutes (the second predetermined period of time) to the start time of the scheduled meeting, the attendance button for each participant is displayed on the screen of the touch type of control panel 23. Hence participants who have come to a meeting room can touch each attendance button on the screen. Only such a touch operation leads to an automatic detection of being absent or present from or in the meeting. With this detection, it is possible to obviate a labor that the ID number of each participant is inputted, thus considerably simplifying the collection of attendance data. In addition, depending on situations where persons who plan to attend a meeting have actually been absent or present from or at the meeting, the attendance data can be utilized in producing reference data or printing which may be conducted later. Such utilization based on the attendance data has not been found in the past.

In conjunction with the attendance detection, for the participants who has been confirmed to be present at a meeting, documents on which an individual name is put on, which is to be used in the meeting, is printed and distributed to each participant on the spot before starting the meeting. Hence, the printing is carried out for only the actual participants, useless printing can be avoided. To be more significant, meeting documents are printed such that the individual's name is indicated as a header on each of the meeting documents. This is helpful for making it clear who has the responsibility of managing each document, whereby the management of documents can also be strengthened, for example, from a viewpoint of preventing the documents from being lost.

Moreover, at an appropriate time before ending a meeting, the booking system for keeping a meeting room for the next meeting will be activated. Hence, based on a decision of the actual participants at the meeting, if necessary, a meeting room for the next meeting can be kept, thus being convenient.

Incidentally, the present invention is not limited to the configurations descried in the above embodiment, but can further be reduced into practice in various modes derived from combinations with known art, by the person skilled in the art without, departing from the gist of the present invention claimed.

For instance, the document managing apparatus and a document managing method according to the present invention will not necessarily be limited to the configuration that employs, as a main component, the computer placed in a center server. Alternatively, the CPU of the MFP apparatus serving as a terminal may be employed as a main processor conducting various types of processing described. A terminal placed in each meeting room is not always confined to the MFP apparatus. Instead, a system made up of a computer such as personal computer and a peripheral such as printer may still be used as the terminal.

Further, the electronic blackboard may be an independent system from the MFP apparatus, not limited to the configuration where the electronic blackboard composes part of the MFP apparatus. In this configuration, a scanner and a printer can be provided in the electronic blackboard, in which the printer engages in printing the image data on sheets of paper and the data on the sheets is scanned by a scanner incorporated in the MFP apparatus.

Furthermore, though the foregoing embodiment provides the configuration in which the functions which reduce the present invention into practice are previously kept in the apparatus, this is not a definitive list. Data that gives the same functions as the above may be downloaded to the apparatus via a network system. Alternatively, the same or similar functions may be given to a recording medium as data, so that the recording medium can be used to install the data from the medium to the apparatus. As such recording medium, any medium including CD-ROMs can be used, provided that program data can be memorized and the memorized data can be read by the apparatus. Furthermore, the data previously obtained through the foregoing installment or downloading may be configured to perform their functions in cooperation with an operating system (OS) in the apparatus.

What is claimed is:

1. A document managing apparatus comprising:
a data storing unit storing into a memory device image data produced by scanning image information; and
a power providing unit allowing only a user to access the image data stored in the memory device by the data storing unit, the user being given a power to perform the access in advance.

2. A document managing apparatus according to claim 1, comprising
a participant storing unit deciding and memorizing a participant,
wherein the user to whom the power is provided by the power providing unit includes at least the participant.

3. A document managing apparatus according to claim 1, comprising a data linking unit having the image data linked with, at least, management data indicative of a day and hour and giving the linked image data to the data storing unit.

4. A document managing apparatus according to claim 3, wherein the management data includes data showing a name of the participant.

5. A document managing apparatus according to claim 3, wherein the data linking unit comprises
a blank area detecting unit detecting a blank area of a predetermined size existing in a scan surface on which the image data is detected and
a data attaching unit attaching the management data to the blank are detected by the blank area detecting unit.

6. A document managing apparatus according to claim 5, wherein
the blank area detecting unit is configured to detect a plurality of blank areas providing the predetermined size in total and
the data attaching unit is configured to attach the management data to the plurality of blank areas every item of the management data.

7. A document managing apparatus according to claim 1, wherein the memory device is a database,
comprising an instruction unit enabling a selective instruction showing that the image data is stored in the memory device in a PDF format or printed on sheets of paper.

8. A document managing apparatus according to claim 1, comprising
a message display instructing unit issuing an instruction for displaying on a monitor a massage informing holding a meeting, when it is a time when a first predetermined period of time is left to a scheduled start time of the meeting.

9. A document managing apparatus according to claim 8, comprising
a list display instructing unit issuing an instruction for displaying on the monitor a list with push buttons to be operated by scheduled participants in the meeting, when it is a time when a second predetermined period of time is left to the scheduled start time and
an attendance checking unit checking attendances of the participants in the meeting in response to reception of a signal showing the that any of the push buttons on the list has been pushed.

10. A document managing apparatus according to claim 9, comprising
a print instructing unit performing an instruction to print previously prepared meeting documents for participants whose attendances have been checked by the attendance checking unit, a name of each of the checked participants being indicated on the meeting documents.

11. A document managing apparatus according to claim 1, comprising
a booking unit for booking a meeting room for a next meeting in accordance with schedules of the participants in the meeting.

12. A document managing apparatus comprising:
data storing means storing into a memory device image data produced by scanning image information; and
power providing means allowing only a user to access the image data stored in the memory device by the data storing means, the user being given a power to perform the access in advance.

13. A document managing apparatus according to claim 12, comprising data linking means having the image data linked with, at least, management data indicative of a day and hour and giving the linked image data to the data storing means.

14. A document managing apparatus according to claim 13, wherein the management data includes data indicating participants who have participated in work of the depiction.

15. A document managing apparatus according to claim 13, wherein the data linking means comprises
blank area detecting means detecting a blank area of a predetermined size existing in a scan surface on which the image data is detected and
data attaching means attaching the management data to the blank are detected by the blank area detecting unit.

16. A document managing apparatus according to claim 15, comprising
list display instructing means issuing an instruction for displaying on the monitor a list with push buttons to be operated by scheduled participants in the meeting, when it is a time when a second predetermined period of time is left to the scheduled start time and
attendance checking means checking attendances of the participants in the meeting in response to reception of a signal showing the that any of the push buttons on the list has been pushed.

17. A document managing method comprising steps of:
receiving image data produced by scanning image information; and
when the image data is stored into a memory device, allowing only a user to access the image data, the user being given a power to perform the access in advance.

18. A document managing method according to claim 17, wherein the image information is information depicted on a depiction screen of an electronic blackboard.

19. A program executable by a computer and causing the computer to function as means comprising:
data storing means storing into a memory device image data produced by scanning image information; and
power providing means allowing only a user to access the image data stored in the memory device by the data storing means, the user being given a power to perform the access in advance.
